(19) United States
(12) Patent Application Publication
(10) Pub. No.: US 2008/0198027 A1
(43) Pub. Date: Aug. 21, 2008

(54) Infrared Laser Based Alarm

(75) Inventor: Renato Bugge, Trondheim (NO)

Correspondence Address: DENNISON, SCHULTZ & MACDONALD, 1727 KING STREET, SUITE 105, ALEXANDRIA, VA, 22314, US

(73) Assignee: INTOPTO AS, Trondheim (NO)

(21) Appl. No.: 11/915,255

(22) PCT Filed: May 26, 2006
(86) PCT No.: PCT/NO2006/000197

§ 371 Date: Nov. 21, 2007

(30) Foreign Application Priority Data
May 31, 2005 (NO) 20052620

(51) Int. Cl. G08B 17/103; G01N 21/00

(52) U.S. Cl. 340/632; 356/437

(57) ABSTRACT

The subject invention relates to a new alarm which is based on using a quarternary tunable Mid-IR laser to measure both particles and gas at the same time. The measurement is done within an area of which the gas of interest will absorb the Mid-IR radiation. By widely tuning the emission wavelength of the laser, several wavelengths can be measured in order to accurately find both gas composition and particle density with one laser based sensor. We tested a new device which use radiation between 2.27 μm and 2.316 μm. Methane gas reduces intensity of the radiation at certain wavelengths in this device, while particles/fog reduce intensity for all wavelengths. In this case, fog should not trigger an alarm, while methane leaks should. This can also be applied for CO and smoke in which one sensor will measure both parameters to sound an alarm instead of just one parameter.

### FIELD OF THE INVENTION

The present invention relates to the use of a tunable Infrared Fabry Perot, Ψ-junction laser or alike to detect CO₂, CO, NH₃, NOₓ, SO₂, CH₄, Hydrocarbon gas/fluids or alike and/or smoke/particles, to the use of laser radiation around the 1.0-10.0 μm wavelength area to detect CO₂, CO, NH₃, NOₓ, SO₂, CH₄, Hydrocarbon gas/fluids or alike and/or smoke/particles, to the use of AlGaAs/InGaAs-, AlGaAsP/InGaAsP-, AlGaAsP/InGaAsN-, AlGaAsSb/InGaAsSb- or AlInGaAsSb/InGaAsSb-laser or alike to detect CO₂, CO, NH₃ NOₓ, SO₂, CH₄, Hydrocarbon gas/fluids or alike and/or smoke/particles and to the use of a laser and p-i-n detector or alike with response around the 1.0-10.0 μm wavelength area to measure and detect CO₂, CO, NH₃, NOₓ, SO₂, CH₄, Hydrocarbon gas/fluids or alike and/or smoke/particles.

The invention also relates to using such gas and/or fluid and/or smoke/particle detection devices in one or two units for detection of gas leak, gas anomality, fluid anomality or fire, to use these units in a gas-/fluid-/fire-alarm or gas-/fluid-/fire-alarm system and in which way the collected data is used to determine an alarm.

### BACKGROUND OF THE INVENTION

Recent advances in mid-IR lasers has shown that it is possible to make lasers in the >2.0 μm area. Such lasers has been used for gas sensing of different gases and has shown to be tunable with current. Current use of these lasers in commercial system has been limited due to the high cost of making them and to the lack of volume markets in which the lasers can be used.

Research has shown that one such volume market is fire and gas detection in which detection of gas and/or smoke has been used to raise an alarm. Currently this is usually done in separate units as current technology does not use IR based laser devices >1 μm for detection, and thus must choose which parameter it should detect. Laser detection of smoke is currently based on short-wavelength lasers (usually <1 μm) in which light is scattered by smoke particles and thus detected (US 2004/0063154 A1). CO detection is usually done by electrochemical sensing or in a few cases by using an IR-lamp for area detection (U.S. Pat. No. 3,677,652). In some systems, these technologies are used separately as devices or combined as multiple devices in one system to improve performance, but this makes the system costly and less robust. An improvement would be to have more than one capability in one device, but this has not been possible before. The IR-lamp has also much less light per wavelength and uses much more power than a laser, which makes it less sensitive and more difficult to integrate in EX secure systems.

We here present a way to detect both CO or other gas and smoke using one technology/device. The basis is that we use a laser which is absorbed by the gas and also detect smoke scattering with the same laser, so that we get two fire-detecting parameters from one device. This enables us to make a cheaper system than current multiple-technology systems, it is more robust as we only use one technology and it will result in fewer false firealarms as all detector units will detect multiple parameters.

The new technology presented here is also unique in the way that it uses a longer wavelength IR laser to detect CO or other gas in addition to smoke/particles. Such wavelengths has better eyesafety than wavelengths <1 μm (ANSI 136.1 laser classification), so that higher power lasers can be used without comprising safety. Higher power means longer range for the laser and higher sensitivity. In the present invention we also show a setup which we used for measuring gas and smoke. The distance between the transmitter (containing the laser) and the receiver (containing the detector) can be much larger than for a laser-based smoke detection system which uses shorter wavelengths. This is due to the higher power which can be used with such a laser.

At the ˜2.3 μm wavelength used in the present invention, the power can be 54 times higher than a laser at 780 nm, and still have the same classification in eye safety (ANSI 136.1 Class 1B or alike).

The higher laser power also permits the laser beam to be remotely or indirectly detected so that gas and/or smoke/particles can be detected from reflected light (from a surface or from particles in the air).

Another possibility is to put both the laser and detector into one unit so that fire detection can be done in a chamber. This can be equipped with one or more mirrors to increase laser beam path length and detect gas and/or particles with higher sensitivity.

### SUMMARY OF THE INVENTION

The scope of the invention shall be considered to be covered by the appended independent claims.

The invention consists of a single near-, mid- or far-IR laser in the 1.0-10.0 μm wavelength area which is used to detect both gas and particles, gas and fluid or fluid and particles.

In one aspect of the invention, the IR laser is a Fabry Perot laser, Ψ-junction laser or alike.

In another aspect of the invention, the gas is CO₂, CO, NH₃, NOₓ, SO₂, CH₄, Hydrocarbon gas/fluid or alike with absorption in the 1.0-10.0 μm wavelength area.

In another aspect of the invention, the particles are inorganic or organic particles in fluid as sand, grains, powder particles, plankton, or alike that scatters laser light.

In another aspect of the invention, the particles are airborne particles as smoke, smog, fog or alike that scatters laser light.

In a further aspect of the invention, the laser is transmitted through an area or a chamber and detected with one or more IR detectors to measure gas and particles, fluid and particles or fluid and gas bubbles.

In another aspect of the invention, the laser beam is reflected multiple times between two mirrors to increase the absorption length before it is detected with a mid-IR detector.

In an even further aspect of the invention, the laser is an GaAs-, GaSb-, InAs-, InSb-, InP-, GaN-, GaP-, AlGaAs-, InGaAs-, AlGaSb-, InGaSb-, InGaAsP-, InGaAsN, AlGaAsSb-, InGaAsSb-, AlInGaAsSb-laser or alike.

In an even further aspect of the invention, the IR laser emits radiation in the 2.0-5.0 μm area.

In an even further aspect of the invention, the IR laser emits radiation in the 2.2-2.6 μm area.

In an even further aspect of the invention, the laser is a heterostructure laser, a multiple quantum well laser or a quantum cascade laser based on one or more of these materials.

In another aspect of the invention, in which active alignment of the detector and laser is used to ease the alignment requirement.

In a further aspect of the invention, adaptive optics, MEMS or electrical motors are used for active alignment.

In another aspect of the invention, passive alignment of the detector and laser, such as multiple detectors is used to ease the alignment requirement

In another aspect of the invention, one detector is used in-axis for direct laser gas detection, and another one is used off-axis for smoke detection by scattered light.

In one aspect of the invention, the IR detector is an InGaSb-, InGaAs-, InGaAsSb- or InAlGaAsSb-semiconductor based detector or alike.

In another aspect of the invention, one or more lenses are used to collimate or focus the laser beam from the laser and onto the detector.

In a further aspect of the invention, the detection is done in a chamber that is perforated in some way as to allow ambient atmosphere, gas and/or smoke to enter the chamber.

In another aspect of the invention, the detection is done in a chamber that is feeded with ambient atmosphere, gas and/or smoke through a gas/air line and pump.

In a further aspect of the invention, several detection points are reached by having several gas/air lines into one chamber.

In another aspect of the invention, the laser beam passes through one or more windows so that more than one area can be measured.

In another aspect of the invention, the laser is tuned in wavelength to scan a gas spectrum so that more absorption data can be collected.

In a further aspect of the invention, the absorption data is used to determine the presence and concentration of a gas for the purpose of sounding an alarm.

In a further aspect of the invention, the absorption data is used to determine the presence and concentration of a particles for the purpose of sounding an alarm.

In an even further aspect of the invention, the laser is pulsed and the detector is coupled with a lock-in-amplifier or fast fourier transform of the signal to reduce background.

In another aspect of the invention, a second or third detector is mounted close to the laser to be used as a reference for the absorption spectrum.

In another aspect of the invention, a known material, fluid and/or gas is placed between the laser and reference detector to be used as a reference for the absorption spectrum.

In a further aspect of the invention, the difference between the absorption spectrum of the ambient gas, fluid and/or atmosphere and the reference detector is used to sound an alarm.

In another aspect of the invention, the measurement detector is used as a reference detector by moving a reference material in between the laser and measurement detector for short periods of time.

In another aspect of the invention, the laser wavelength is tuned by changing the amount, the duty cycle and/or frequency of the current to the laser.

In another aspect of the invention, heated lenses, windows or mirrors are used in the beam path of the laser to prevent frost formation on one or more of such.

In another aspect of the invention, part of the unit is hermetically sealed or filled with plastic or alike, to prevent corrosive damage from the ambient atmosphere to the components inside.

### BRIEF DESCRIPTION OF THE FIGURES

FIG. 1 shows schematics of laser/lens/detector for a gas and/or fire alarm, along with power supply, preamplifier and controller electronics.

FIG. 2 shows output spectrum of the 2.3 μm laser used in the gas detection test. At 205 mA the laser wavelength was ˜2.277 μm, while at 350 mA the wavelength was ˜2.316 μm.

FIG. 3 shows measured detector signal as a function of pulsed laser current [50% duty]. With CH₄ in the 5 cm gas cell, some of the laser light is absorbed.

FIG. 4 shows the calculated gas absorption spectrum of CH₄, from the data in FIG. 3. CH₄ gas absorption data from the HITRAN database is shown for comparison (with another scale). The data overlap, but the use of a cheap FP laser gives broader features.

FIG. 5 shows gas absorption data of CO from the HITRAN database.

FIG. 6 shows the Ψ-junction laser test results at room temperature with pulsed operation. The laser emitted single mode from 2.353 μm to 2.375 μm, i.e. a single mode tunability range of 22 nm at room temperature. Full width half maximum of the emission was 0.47 nm for 2.353 μm and 0.57 nm for 2.375 μm emission. The 16 mA spectrum is shifted downwards for clarity.

FIG. 7 shows schematics showing laser/lens/detector for a gas and/or fluid and/or particle alarm/anomality sensor, along with power supply, preamplifier and controller electronics.

FIG. 8 shows measured absorbance of water, methanol and ethanol around 2.3 μm wavelength. The figure shows how different hydrocarbon liquids yield different absorption spectra which can be detected.

FIG. 9. A reference gas or material is used along with a second detector to calibrate the measurement. Such self-calibrated operation results in improved accuracy without the need for accurate control of laser current and temperature.

FIG. 10. A extra detector measure the reflected/backscattered IR laser radiation from particles/obstructions to obtain volume information. With fog obscuring the receiver detector (on the right side), the extra detector will be able to obtain an absorption spectrum of the gas.

FIG. 11. The receiver is omitted so that gas is measured through reflection/backscattering of IR laser radiation by particles or obstructions such as fog, snow, ice, sand or alike. The detector can be tilted one or two ways to align it to observe gas in the desired area/point or for survey.

### DETAILED DESCRIPTION OF THE INVENTION

The present invention is described with basis in the following, non-limiting examples. The patent is intended to cover all possible variations and adjustments, which may be made, based on the appended claims.

### EXAMPLES

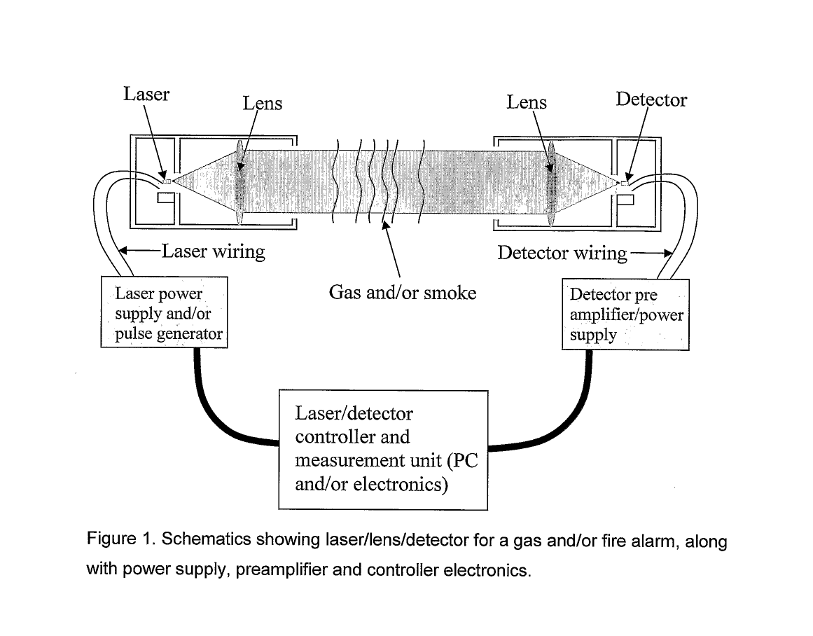

A system was built on the basis of a FPCM-2301 Mid-IR Fabry Perot laser at ˜2.3 μm (from Intopto A/S, Norway) which was mounted into a “transmitter”-housing with a collimating lens and power supply as shown in FIG. 1. The power supply of the tested system was actually mounted on the backside of the housing (unlike in the figure which has a separate box), so that the distance between the power supply and the laser was less. In front of the laser, we mounted a Concave-flat lens which had the laser in its focal point so that the laser beam was collimated into a parallel beam. This made it easy to adjust distance between the transmitter (containing the laser) and the detector. As shown in FIG. 1, the detector was mounted in a “reciever”-housing with a flat-Concave lens so that most of the laser beam was focused onto the detector. The pin-detector in the housing (a 2.3 μm InGaAs pin-detector from Sensors Unlimited Ltd., USA) was connected to a preamplifier which was mounted on the receiver to reduce the distance between detector and the preamplifier.

In order to improve signal-to-noise ratio, we also tried to connect the laser and detector to a pulse generator and lock-in-amplifier. This reduced background noise so that the measurement was much more sensitive. For simple measurement devices, the pulse generator and lock-in amplifier is not needed.

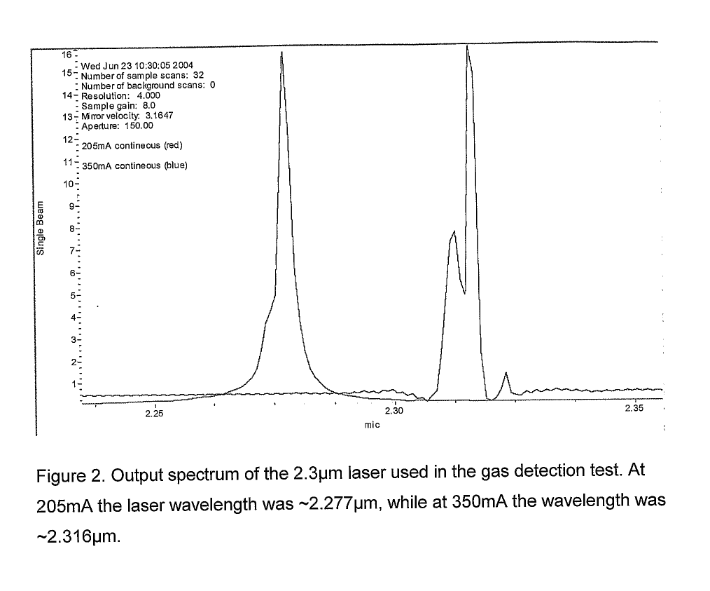

For spectral tuning of the laser, we tried both current and duty cycle variation to change the output wavelength of the laser. At low continuous currents (˜200 mA), the laser emitted at around 2.27 μm wavelength, while at high continuous currents (˜350 mA), the laser emission had changed up to 2.316 μm (FIG. 2). As the tested system was with a Fabry Perot laser, the laser had one to three modes lasing with mostly one mode much stronger than the other two. Mode spacing of the laser was around 3 nm, so that the tuning from 2.27 μm to 2.32 μm could be done in 3 nm “steps”. Between two such steps, the laser output was observed to increase in one mode while it decreased in another so that the collected data was a product of the absorption in a pulse with a FWHM of around 3-6 nm.

Another way of tuning the laser is to use a pulse generator and change the duty cycle of the pulse from 1% to 99%, instead of changing current. This produced more or less the same results as the current tuning, but as the current could be kept high in the whole tuning range, it improved the signal power for the shortest wavelengths. Such “pulse-tuning” can also be combined with a lock-in-amplifier to increase signal-to-noise ration, but this was not tested here. The “pulse-tuning” has another advantage in that it can be easily controlled and collected by using digital signal processing (microcontroller or PC), which reduces the need for analog control of the laser current (and thus reduce cost).

In the gas absorption test, a PC was used as a controller for the laser and detector, so that data could be collected automatically. The PC can be exchanged with a similar programmable microcontroller or electronics to do the analysis/detection of the gas.

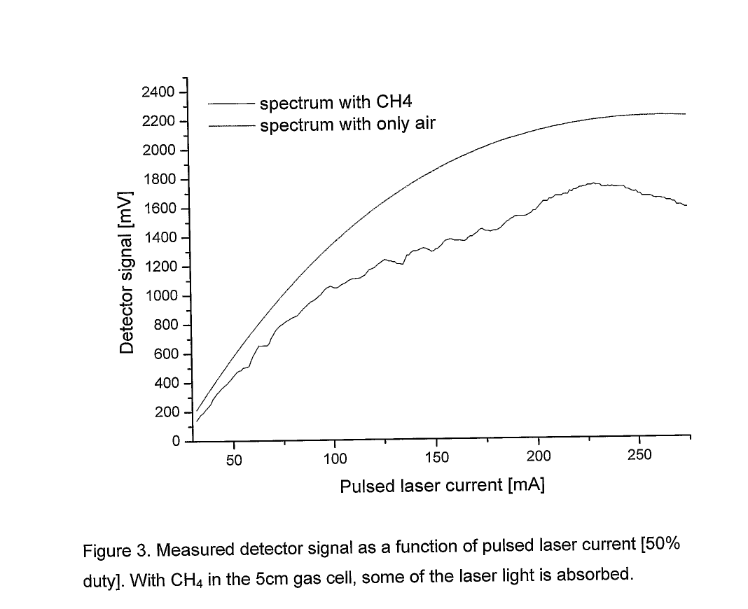

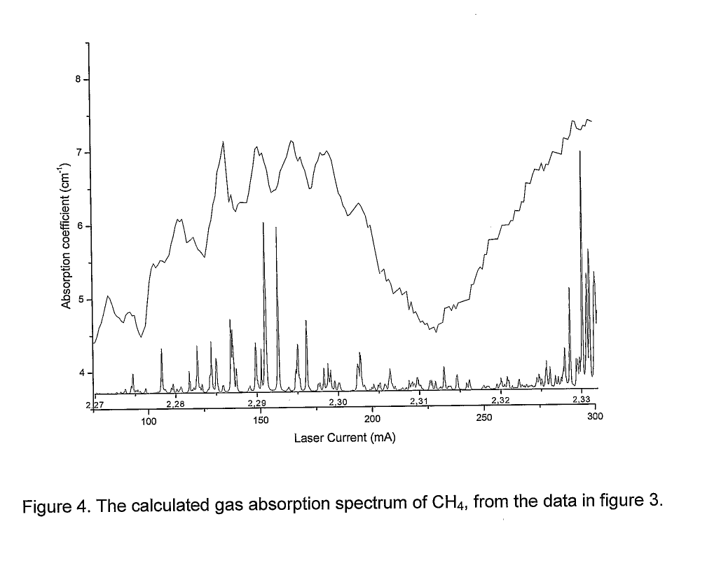

Several gases can be detected with such a setup, depending on the wavelength of the laser. FIGS. 3 and 4 shows a collected data and resulting gas absorption spectrum from a pulsed laser sent though a 5 cm gas cell containing CH₄. In this collection, the laser was tuned by changing current and shows absorption peaks around the gas absorption lines. The peaks are much broader and has less detail due to the fact that laser emission is broader than the gas absorption lines. From this spectrum one can calculate the CH₄ concentration, and by sweeping the laser spectrum and collecting many datapoints, we calculated a sensitivity of ˜5 ppm*m in one second. Thus, a 10 meter transmission length will have a 0.5 ppm sensitivity for one second integration time.

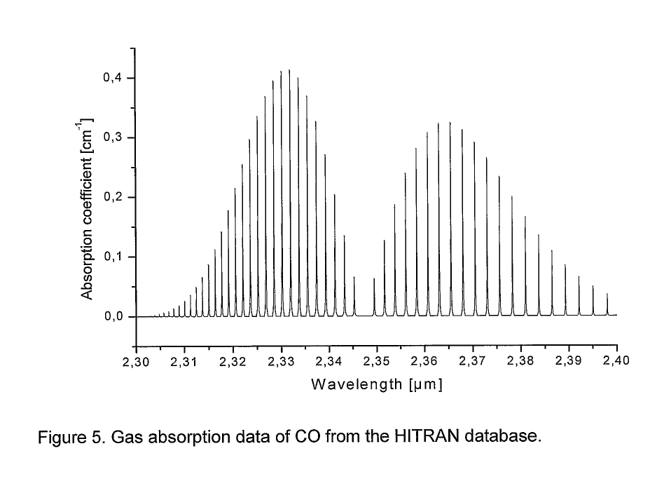

By detecting CO gas the same way (absorption around 2.3 μm), CO gas concentration can be measured the same way as CH₄. FIG. 5 shows the HITRAN absorption data around ˜2.3 μm wavelength. To detect smoke, one can either look at the relative absorption in the whole spectrum, or use a second detector to look for scattered light by particles. Scattering is mainly wavelength insensitive in such a small wavelength area so that smoke scattering will appear to increase absorption in the whole area, i.e. not appear as peaks. For example, FIG. 4 shows an absorption coefficient of 4.5 cm⁻¹ at 2.31 μm, while it is 7 cm⁻¹ at 2.30 μm (or ˜160% that of 2.31 μm). For smoke absorption this would be equally large for the two wavelengths (i.e. the one at 2.30 μm would be 100% that of 2.31 μm). We can then calculate the amount of smoke and CH₄ by:

α_{CH4}(2.31 μm)=1.6·α_{CH4}(2.30 μm)

α_{Smoke}(2.31 μm)=α_{Smoke}(2.30 μm)

were α_{CH4}(λ) and α_{Smoke}(λ) is the absorption coefficient of methane and smoke correspondingly. The measured absorption coefficient α(λ) would be related to this through:

α(2.30 μm)=α_{CH4}(20.30 μm)+α_{Smoke}(2.30 μm)

α(2.31 μm)=α_{CH4}(2.31 μm)+α_{Smoke}(2.31 αm)=1.6·α_{CH4}(2.30 μm)+α_{Smoke}(2.30 μm)

which we rewrite as:

α_{CH4}(2.30 μm)=α(2.31 μm)−α(2.30 μm)/0.6

α_{Smoke}(2.30 μm)=α(2.31 μm)−0.4·α(2.30 μm)/0.6

As path lengths are equal, these absorption coefficients would be directly related to the percentage of Methane and Smoke through calibration (i.e. a calibration factor correction). This could in turn be used to set alarm levels of such.

The above example demonstrate the ability of this system to measure both gas and smoke at once by utilizing the tuneability of a laser, and comparing the absorption at different wavelengths to deconvolute amount of gas and smoke/particles in the probed environment. By using the whole spectrum instead of only two wavelengths, better statistics are obtained and the sensitivity is higher. For such a system the relation would be:

α(λ)=K(λ)·α_{CH4}(λ)+α_{Smoke}(λ)

In which the reference factor for the gas is replaced with a normalized reference spectrum K(λ). Other methods to improve the detection include peak positioning (for wavelength calibration) or by looking at the derivative of the spectrum to deconvolute gas absorption peaks (assuming the smoke scattering is equal through the acquired spectrum range).

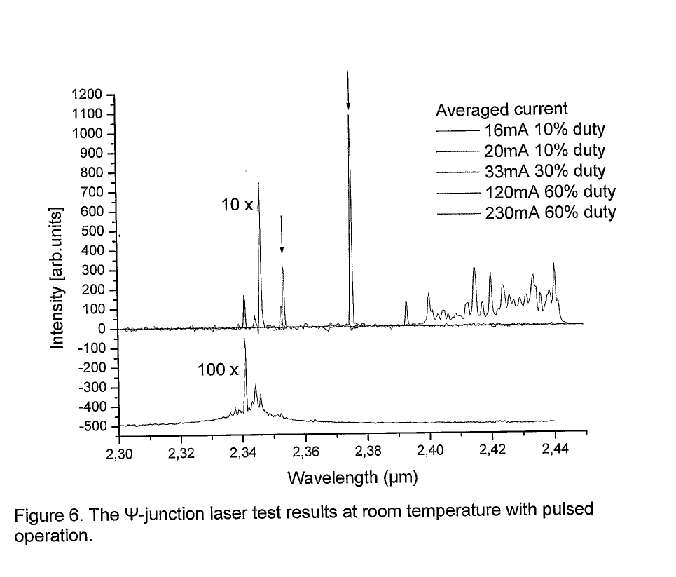

Another way to measure gas absorption and smoke scattering is to use a single mode tunable laser as a junction laser or alike. FIG. 6 shows the output spectrum of one of our Ψ-junction laser that emits single mode radiation. The benefit of using single mode radiation is that it has much narrower linewidth so that individual gas lines can be resolved. The Ψ-junction laser proposed here has a linewidth of 0.52 nm±0.05 nm which is good enough to resolve the CO-absorption lines shown in FIG. 5. For example, there is a strong line at 2365.54 nm which can be scanned with the Ψ-junction laser without interference from the 2363.12 nm or 2368.00 nm lines beside this one. Such scanning will give even higher detection limits by combining narrow scanning and wide tuneability (to scan several lines). As for the Fabry Perot laser, this can also be used for detection of particles/smoke, and will also give a higher sensitivity for such as deconvolution of strong and narrow peaks are more easily done.

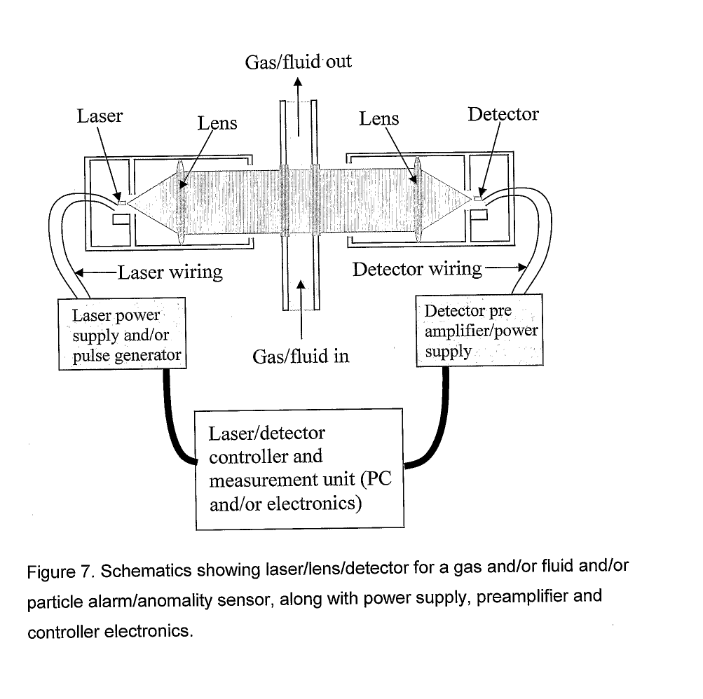

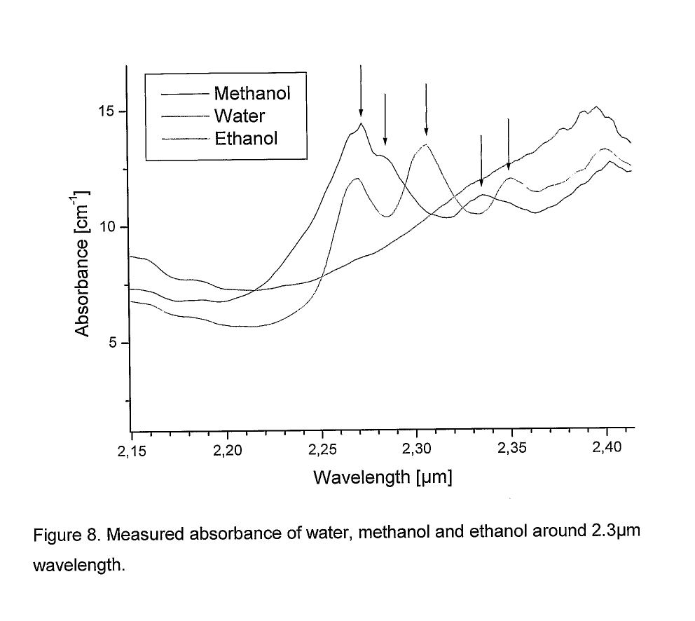

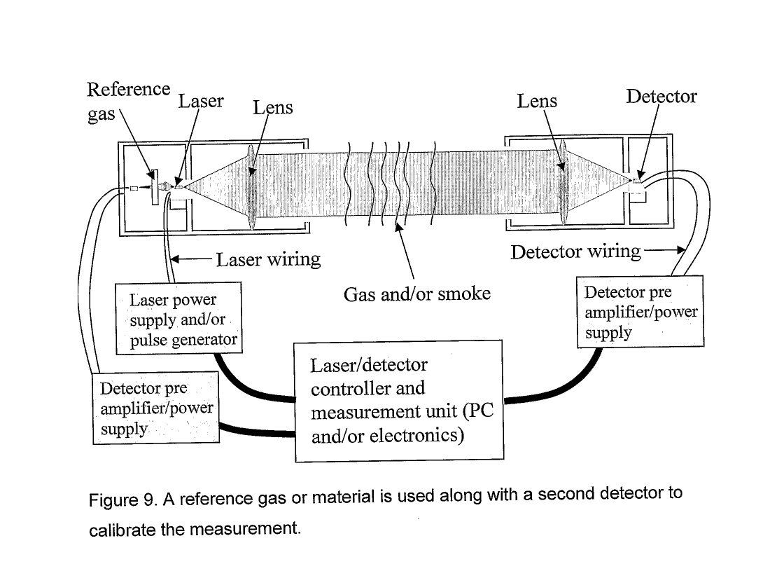

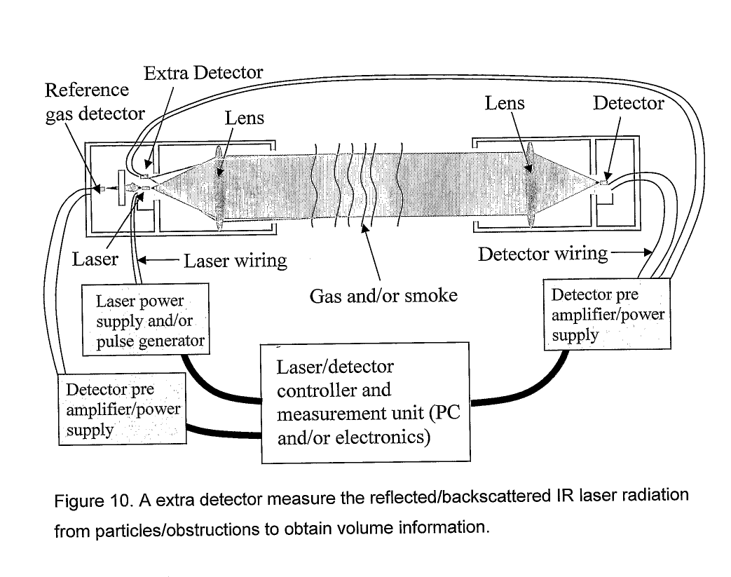

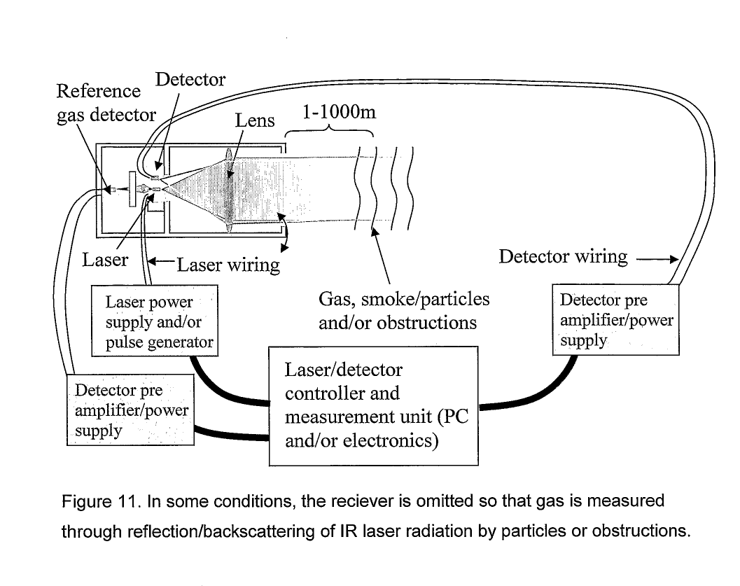

FIG. 7 also show how this can be used to detect a mixture of gas and/or fluids and particles. As with airborne particles, particles in fluids or gas bubbles in fluids will scatter light and can be detected the same way as discussed above. From our measurements in FIG. 8 we also showed how hydrocarbon liquids as methanol, ethanol and alike can be detected with a Mid-IR laser from their absorption peaks. This enable detection of critical components in fluids as unwanted chemicals or particles for alarming an operator. FIG. 9 shows how a reference is used to calibrate the absorption data by comparing with the signal from the two detectors. This approach omits the need for accurate wavelength control without removing the accuracy of the system. In FIG. 10, a extra detector is used to measure reflected/backscattered IR radiation from the Mid-IR laser. By tuning the wavelength, this detector can also be used to measure gas and particles, but will be dependent on a scattering/reflecting medium such as fog, dust, snow or a solid medium as ice or alike. The reference signal from the calibration gas is used as a calibration in this setting too. FIG. 11 shows the same setup as FIG. 10, but without a receiver. Instead, the extra detector in FIG. 10 is used to measure both particles and gas. Such a setup is advantageous in the case of long measuring distances or if an area scan is needed. A scan can be done by aligning the laser in different directions using motors, adaptive optics or MEMS. Table 1 shows a list of identified gases and wavelengths which can be measured with the current invention.

TABLE 1
List of some of the gases which are detectable with the current invention.

| Gas | Relevant detection area | Primary dangers, Were used/found |
|---|---|---|
| NH₃—Ammonia | 2.2-2.35 μm | Very Poisonous/Corrosive, Industry |
| N₂O—Laughter gas | 2.1-2.13 μm | Dangerous in large doses/oxidizing, Pharma/Lab |
| NO₂—Nitrogendioxide | ~2.38 μm | Extremly Poisonous/oxidizing, Diesel Exhaust |
| CO₂—Carbondioxide | 1.9-2.1 μm & 2.6-2.9 μm | Dangerous > 10%, Industry/Fire/Exhaust |
| CO—Carbonmonoxide | 2.3-2.4 μm | Extremly Poisonous/Explosive, Fires/Exhaust |
| HBr—Hydrogenbromide | 1.95-2.05 μm | Extremly Poisonous/Corrosive, Lab |
| HI—HydrogenIodide | 2.25-2.35 μm | Extremly Poisonous/Corrosive, Lab |
| CH₄—Methane | 2.2-2.4 μm & 3.1-3.6 μm | Poisonous/Explosive, Natural gas, Waste |
| C₂H₆—Ethane | 2.2-2.5 μm & 3.2-3.6 μm | Poisonous/Explosive, Natural gas |
| C₃H₈—Propane | 2.2-2.5 μm & 3.3-3.6 μm | Poisonous/Explosive, Propane gas(heating/cooking) |
| C₄H₁₀—Buthane | 2.2-2.5 μm & 3.3-3.6 μm | Poisonous/Explosive, Butane gas(heating/cooking) |
| C₇H₁₆—Hepthane | 2.3-2.5 μm & 3.3-3.7 μm | Very Poisonous/Explosive, Gas stations |
| Isooctane | 2.3-2.5 μm & 3.3-3.7 μm | Extremly Poisonous/Explosive, Gas stations |
| Xylene (all three) | 2.2-2.5 μm | Poisonous/Inflammable, Exhaust |
| HDO | 2.35-2.36 μm | Not dangerous, Heavy water precursor |
| Dicloromethane | 2.2-2.35 μm | Very Poisonous/Explosive, Natural gas/Industry |
| Hydrazine | 2-2.5 μm & 2.9-3.1 μm | Poisonous/Explosive, Rockets/Industry |
| Formaldehyde | 2.15-2.25 μm | Poisonous/Inflammable, Exhaust/Natural |
| | | gas/Breweries |
| Ethene | 2.1-2.4 μm & 3.1-3.4 μm | Poisonous/Inflammable, Exhaust/Oil spills |
| Buthene (1&2) | 2.2-2.5 μm | Poisonous/Inflammable, Exhaust |
| Prophene | 2.2-2.4 μm | Poisonous/Inflammable, Exhaust |
| H₂S—Hydrogensulfide | 2.55 μm | Very Poisonous, Platforms/Industry |
| Benzene | 2.4-2.5 μm | Poisonous/Inflammable, Rockets/Industry |
| HCN | ~2.5 μm | Extremly Poisonous, Industry |
| HF—Hydroflouric acid | 2.4-2.7 μm | Extremly Poisonous, Industry/Lab |
| O₃—Ozone | 2.4-2.5 μm | Poisonous/Oxidizing, Industry |
| SO₂—Sulphurdioxide | 2.4-2.5 μm & 2.7-2.8 μm | Poisonous/Corrosive, Exhaust/Industry |
| NO—Nitrogenmonoxide | 2.6-2.7 μm | Poisonous/Inflammable/Oxidizing, Exhaust |
| SiH₄—Silane | 2.2-2.4 μm & 3.1-3.4 μm | Pyrophoric/Explosive/Glass dust (Harmful), Industry |
| GeH₄—Germane | 2.3-2.5 μm | Pyrophoric/Explosive/Glass dust (Harmful), Industry |
| PH₃—Phosphine | 2.1-2.3 μm & 2.8-3-1 μm | Pyrophoric/Explosive/Poisonous, Industry |
| Nicotine (50° C.) | 3.2-3.6 μm | Poisonous, Industry |

1. A method in which an InGaAsP-, InGaAsN-, AlGaAsSb-, InGaAsSb or AlInGaAsSb-based laser in the 1.0-10.0 μm wavelength area is used to detect both gas and particles, gas and fluid or fluid and particles.

2. A method as described in claim 1, in which the IR laser emits radiation in the 2.0-3.9 μm area.

3. A method as described in claim 1, in which the IR laser emits radiation in the 2.1-3.4 μm area.

4. A method as described in claim 1, in which the IR laser is a Fabry Perot laser, Ψ-junction laser or alike.

5. A method as described in claim 4, in which the laser is a heterostructure laser, a multiple quantum well laser or a quantum cascade laser based on one or more of these materials.

6. A method as described in claim 5, in which the laser is tuned in wavelength to scan a gas spectrum so that absorption data from more than one wavelength is collected.

7. A method as described in claim 6, in which the absorption data is used to determine the presence and concentration of a gas for the purpose of sounding an alarm.

8. A method as described in claim 7, in which the absorption data is also used to determine the presence and concentration of particles for the purpose of sounding an alarm.

9. A method as described in claim 7, in which the gas is CO₂, CO, NH₃, NOₓ, SO₂, CH₄, Hydrocarbon gas/fluid or alike.

10. A method as described in claim 8, in which the particles are inorganic or organic particles in fluid as sand, grains, powder particles, plankton, or alike or particles in gas as smoke, smog, fog or alike that scatters laser light.

11. A method as described in claim 8, in which the laser is transmitted through an area or a chamber and detected with one or more IR detectors to measure gas and particles, fluid and particles or fluid and gas bubbles.

12. A method as described in claim 11, in which the laser beam is reflected multiple times between two mirrors to increase the absorption length before it is detected with a mid-IR detector.

13. A method as described in claim 11, in which adaptive optics, MEMS or electrical motors are used for active alignment of laser and detector.

14. A method as described in claim 11, in which passive alignment of the detector and laser, such as multiple detectors is used to ease the alignment requirement.

15. A method as described in claim 11, in which one detector is used in-axis for direct laser gas detection, and another one is used off-axis for smoke detection by scattered light.

16. A method as described in claim 11, in which the IR detector is an InGaSb-, InGaAs-, InGaAsSb- or InAlGaAsSb-semiconductor based detector or alike.

17. A method as described in claim 12, in which the detection is done in a chamber that is perforated in some way as to allow ambient atmosphere, gas and/or smoke to enter the chamber.

18. A method as described in claim 17, in which the detection is done in a chamber that is feeded with ambient atmosphere, gas and/or smoke through a gas/air line and pump.

19. A method as described in claim 11, in which the several detection points are reached by having several gas/air lines into one chamber/area.

20. A method as described in claim 11, in which the laser is pulsed and the detector is coupled with a lock-in-amplifier or fast fourier transform of the signal to reduce background.

21. A method as described in claim 11, in which a second or third detector is mounted close to the laser to be used as a reference for the absorption spectrum.

22. A method as described in claim 11, in which a known material, fluid and/or gas is placed between the laser and reference detector to be used as a reference for the absorption spectrum.

23. A method as described in claim 11, in which the difference between the absorption spectrum of the ambient gas, fluid and/or atmosphere and the reference detector is used to sound an alarm.

24. A method as described in claim 11, in which the measurement detector is used as a reference detector by moving a reference material in between the laser and measurement detector for short periods of time.

25. A method as described in claim 6, in which the laser wavelength is tuned by changing the amount, the duty cycle and/or frequency of the current to the laser.

26. A product in which an InGaAsP-, InGaAsN-, AlGaAsSb-, InGaAsSb or AlInGaAsSb-based laser in the 1.0-10.0 μm wavelength area is used to detect both gas and particles, gas and fluid or fluid and particles.

27. A product as described in claim 26, in which the IR laser emits radiation in the 2.0-3.9 μm area.

28. A product as described in claim 26, in which the IR laser emits radiation in the 2.1-3.4 μm area.

29. A product as described in claim 26, in which the IR laser is a Fabry Perot laser, Ψ-junction laser or alike.

30. A product as described in claim 29, in which the laser is a heterostructure laser, a multiple quantum well laser or a quantum cascade laser based on one or more of these materials.

31. A product as described in claim 30, in which the laser is tuned in wavelength to scan a gas spectrum so that absorption data from more than one wavelength is collected.

32. A product as described in claim 31, in which the absorption data is used to determine the presence and concentration of a gas for the purpose of sounding an alarm.

33. A product as described in claim 32, in which the absorption data is also used to determine the presence and concentration of particles for the purpose of sounding an alarm.

34. A product as described in claim 32, in which the gas is CO₂, CO, NH₃, NOₓ, SO₂, CH₄, Hydrocarbon gas/fluid or alike.

35. A product as described in claim 33, in which the particles are inorganic or organic particles in fluid as sand, grains, powder particles, plankton, or alike or particles in gas as smoke, smog, fog or alike that scatters laser light.

36. A product as described in claim 33, in which the laser is transmitted through an area or a chamber and detected with one or more IR detectors to measure gas and particles, fluid and particles or fluid and gas bubbles.

37. A product as described in claim 36, in which the laser beam is reflected multiple times between two mirrors to increase the absorption length before it is detected with a mid-IR detector.

38. A product as described in claim 36, in which adaptive optics, MEMS or electrical motors are used for active alignment of laser and detector.

39. A product as described in claim 36, in which passive alignment of the detector and laser, such as multiple detectors is used to ease the alignment requirement.

40. A product as described in claim 36, in which one detector is used in-axis for direct laser gas detection, and another one is used off-axis for smoke detection by scattered light.

41. A product as described in claim 36, in which the IR detector is an InGaSb-, InGaAs-, InGaAsSb- or InAlGaAsSb-semiconductor based detector or alike.

42. A product as described in claim 37, in which the detection is done in a chamber that is perforated in some way as to allow ambient atmosphere, gas and/or smoke to enter the chamber.

43. A product as described in claim 42, in which the detection is done in a chamber that is feeded with ambient atmosphere, gas and/or smoke through a gas/air line and pump.

44. A product as described in claim 36, in which the several detection points are reached by having several gas/air lines into one chamber/area.

45. A product as described in claim 36, in which the laser is pulsed and the detector is coupled with a lock-in-amplifier or fast fourier transform of the signal to reduce background.

46. A product as described in claim 36, in which a second or third detector is mounted close to the laser to be used as a reference for the absorption spectrum.

47. A product as described in claim 36, in which a known material, fluid and/or gas is placed between the laser and reference detector to be used as a reference for the absorption spectrum.

48. A product as described in claim 36, in which the difference between the absorption spectrum of the ambient gas, fluid and/or atmosphere and the reference detector is used to sound an alarm.

49. A product as described in claim 36, in which the measurement detector is used as a reference detector by moving a reference material in between the laser and measurement detector for short periods of time.

50. A product as described in claim 31, in which the laser wavelength is tuned by changing the amount, the duty cycle and/or frequency of the current to the laser.
